(19) United States
(12) Patent Application Publication
(10) Pub. No.: US 2019/0057465 A1
(43) Pub. Date: Feb. 21, 2019

(54) HOME RECOMMENDATION TOOL

(71) Applicant: CARRIER CORPORATION, Jupiter, FL (US)

(72) Inventor: Tony Spath, West Hartford, CT (US)

(21) Appl. No.: 16/104,160

(22) Filed: Aug. 17, 2018

Related U.S. Application Data
(60) Provisional application No. 62/547,250, filed on Aug. 18, 2017.

(51) Int. Cl. G06Q 50/16; G06F 17/30

(52) U.S. Cl. CPC G06Q 50/16; G06F 17/30864

(57) ABSTRACT

A method of finding a real estate listing similar to a current residence of a buyer is provided comprising: receiving a real estate search request from a real estate matching application operating on a user device of the buyer, the real estate search request including a desired location; determining a current residence; obtaining one or more property variables of the current residence; obtaining a value for each of the one or more property variables; determining a first real estate listing within a selected distance of the desired location; obtaining a value for each of the one or more property variables for first real estate listing; determining a total score of the first real estate listing in response to the value for each of the one or more property variables for the current residence and first real estate listing; and sharing total score of first real estate listing with buyer.

### CROSS-REFERENCE TO RELATED APPLICATIONS

This application claims priority to and the benefit of U.S. Provisional Patent Application Ser. No. 62/547,250, filed on Aug. 18, 2017, and all the benefits accruing therefrom under 35 U.S.C. § 119, the content of which is incorporated herein in its entirety by reference.

### BACKGROUND

The subject matter disclosed herein generally relates to real estate searching systems, and more particularly, to a system and method to buyers with real estate properties.

In an increasingly transient society, home owners typically desire to relocate more frequently than in previous generations. When home owners desire a new geographical location, they typically would like to maintain their current lifestyle and often desire a new home similar to the home they will be leaving behind.

### BRIEF SUMMARY

According to one embodiment, a method of finding a real estate listing similar to a current residence of a buyer is provided. The method comprising: receiving a real estate search request from a real estate matching application operating on a user device of the buyer, the real estate search request including a desired location; determining a current residence of the buyer; obtaining one or more property variables of the current residence of the buyer; obtaining a value for each of the one or more property variables for the current residence of the buyer; determining a first real estate listing within a selected distance of the desired location; obtaining a value for each of the one or more property variables for the first real estate listing; determining a total score of the first real estate listing in response to the value for each of the one or more property variables for the current residence of the buyer and the value for each of the one or more property variables for the first real estate listing; and sharing the total score of the first real estate listing with the buyer.

In addition to one or more of the features described above, or as an alternative, further embodiments may include that the determining a total score of the first real estate listing further comprises: determining a percentage change between the value for each of the one or more property variables for the current residence and the value for each of the one or more property variables for first real estate listing; and summing the percentage change for each of the one or more property variables to determine a total score.

In addition to one or more of the features described above, or as an alternative, further embodiments may include that the determining a total score of the first real estate listing further comprises: determining a percentage change between the value for each of the one or more property variables for the current residence and the value for each of the one or more property variables for first real estate listing; multiplying each of the percentage change for each of the one or more property variables by a selected variable multiplier; and summing the percentage change for each of the one or more property variables to determine a total score.

In addition to one or more of the features described above, or as an alternative, further embodiments may include determining a second real estate listing within a selected distance of the desired location; obtaining a value for each of the one or more property variables for the second real estate listing; determining a total score of the second real estate listing in response to the value for each of the one or more property variables for the current residence of the buyer and the value for each of the one or more property variables for the second real estate listing; and sharing with the buyer the total score of the second real estate listing.

In addition to one or more of the features described above, or as an alternative, further embodiments may include that the determining a total score of the second real estate listing further comprises: determining a percentage change between the value for each of the one or more property variables for the current residence and the value for each of the one or more property variables for second real estate listing; and summing the percentage change for each of the one or more property variables to determine a total score.

In addition to one or more of the features described above, or as an alternative, further embodiments may include that the determining a total score of the second real estate listing further comprises: determining a percentage change between the value for each of the one or more property variables for the current residence and the value for each of the one or more property variables for second real estate listing; multiplying each of the percentage change for each of the one or more property variables by a selected variable multiplier; and summing the percentage change for each of the one or more property variables to determine a total score.

In addition to one or more of the features described above, or as an alternative, further embodiments may include sorting the first real estate property and the second real estate property in order of ascending total score.

In addition to one or more of the features described above, or as an alternative, further embodiments may include sorting the first real estate property and the second real estate property in order of ascending total score.

In addition to one or more of the features described above, or as an alternative, further embodiments may include activating an alarm on a user device of the buyer through a real estate application when the total score of the first real estate property is received.

In addition to one or more of the features described above, or as an alternative, further embodiments may include displaying the total score of the first real estate property on a user device of the buyer through a real estate application when the total score of the first real estate property is received.

In addition to one or more of the features described above, or as an alternative, further embodiments may include activating an alarm on a user device of the buyer through a real estate application when the total score of the second real estate property is greater than the total score of the first real estate property.

According to another embodiment, a listing recommendation server is provided. The listing recommendation server comprising: a processor; a memory comprising computer-executable instructions that, when executed by the processor, cause the processor to perform operations, the operations comprising: determining a current residence of the buyer; obtaining one or more property variables of the current residence of the buyer; obtaining a value for each of the one or more property variables for the current residence of the buyer; determining a first real estate listing within a selected distance of the desired location; obtaining a value for each of the one or more property variables for the first real estate listing; determining a total score of the first real estate listing in response to the value for each of the one or more property variables for the current residence of the buyer and the value for each of the one or more property variables for the first real estate listing; and sharing the total score of the first real estate listing with the buyer.

In addition to one or more of the features described above, or as an alternative, further embodiments may include that the determining a total score of the first real estate listing further comprises: determining a percentage change between the value for each of the one or more property variables for the current residence and the value for each of the one or more property variables for first real estate listing; and summing the percentage change for each of the one or more property variables to determine a total score.

In addition to one or more of the features described above, or as an alternative, further embodiments may include that the determining a total score of the first real estate listing further comprises: determining a percentage change between the value for each of the one or more property variables for the current residence and the value for each of the one or more property variables for first real estate listing; multiplying each of the percentage change for each of the one or more property variables by a selected variable multiplier; and summing the percentage change for each of the one or more property variables to determine a total score.

In addition to one or more of the features described above, or as an alternative, further embodiments may include that the operations further comprise: determining a second real estate listing within a selected distance of the desired location; obtaining a value for each of the one or more property variables for the second real estate listing; determining a total score of the second real estate listing in response to the value for each of the one or more property variables for the current residence of the buyer and the value for each of the one or more property variables for the second real estate listing; and sharing with the buyer the total score of the second real estate listing.

In addition to one or more of the features described above, or as an alternative, further embodiments may include that the determining a total score of the second real estate listing further comprises: determining a percentage change between the value for each of the one or more property variables for the current residence and the value for each of the one or more property variables for second real estate listing; and summing the percentage change for each of the one or more property variables to determine a total score.

In addition to one or more of the features described above, or as an alternative, further embodiments may include that the determining a total score of the second real estate listing further comprises: determining a percentage change between the value for each of the one or more property variables for the current residence and the value for each of the one or more property variables for second real estate listing; multiplying each of the percentage change for each of the one or more property variables by a selected variable multiplier; and summing the percentage change for each of the one or more property variables to determine a total score.

In addition to one or more of the features described above, or as an alternative, further embodiments may include that the operations further comprise: sorting the first real estate property and the second real estate property in order of ascending total score.

In addition to one or more of the features described above, or as an alternative, further embodiments may include that the operations further comprise: sorting the first real estate property and the second real estate property in order of ascending total score.

According to another embodiment, a computer program product tangibly embodied on a computer readable medium is provided. The computer program product including instructions that, when executed by a processor, cause the processor to perform operations comprising: determining a current residence of the buyer; obtaining one or more property variables of the current residence of the buyer; obtaining a value for each of the one or more property variables for the current residence of the buyer; determining a first real estate listing within a selected distance of the desired location; obtaining a value for each of the one or more property variables for the first real estate listing; determining a total score of the first real estate listing in response to the value for each of the one or more property variables for the current residence of the buyer and the value for each of the one or more property variables for the first real estate listing; and sharing the total score of the first real estate listing with the buyer.

Technical effects of embodiments of the present disclosure include a real estate searching system configure to find new homes that are similar to a buyer's existing home.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

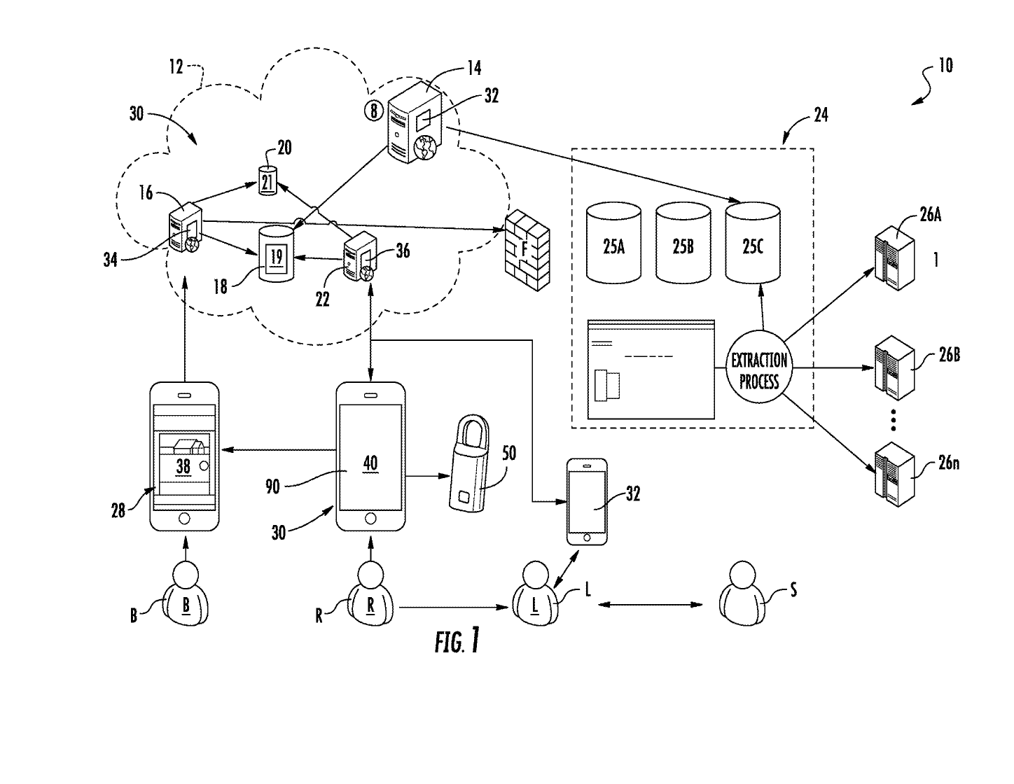

FIG. 1 illustrates a general schematic system diagram of a real estate application system, in accordance with an embodiment of the disclosure;

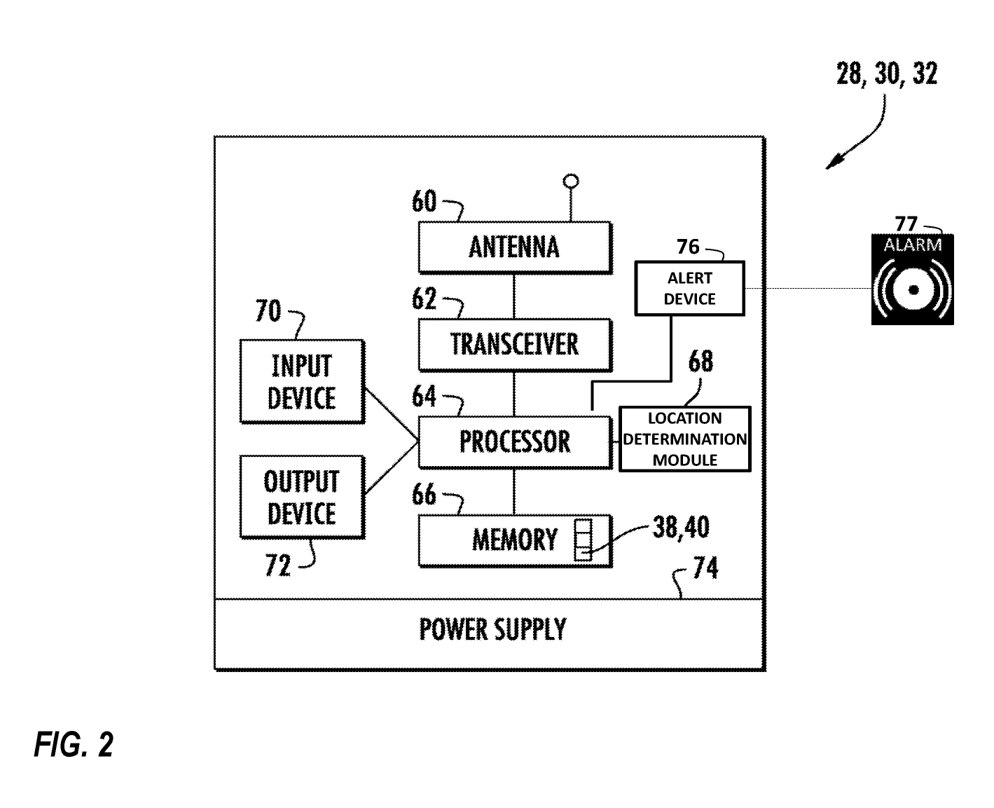

FIG. 2 illustrates a general schematic system diagram of a user device, in accordance with an embodiment of the disclosure;

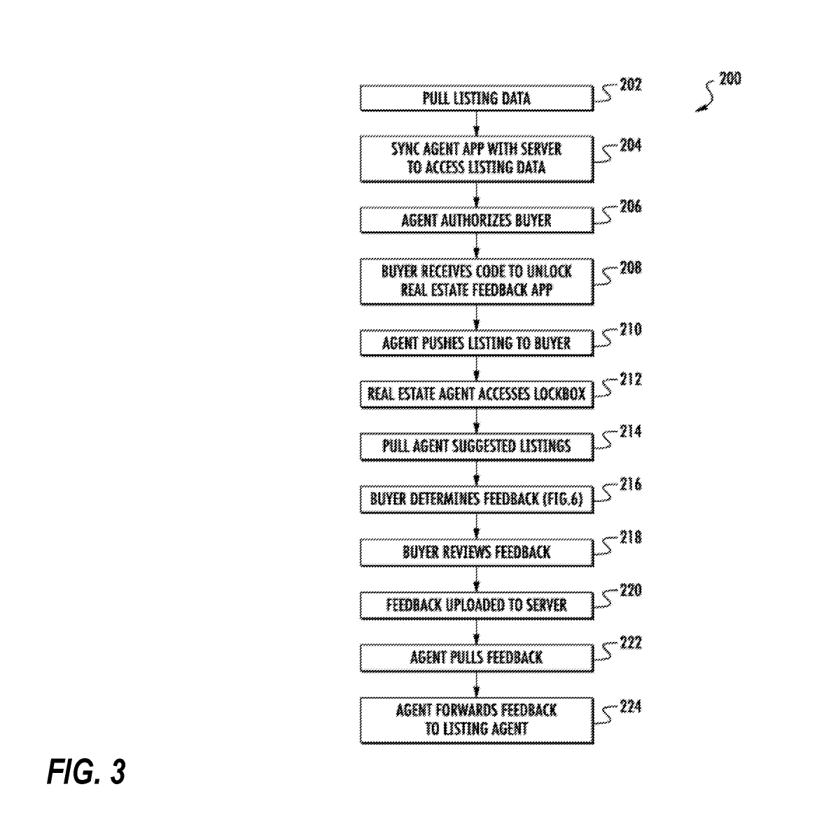

FIG. 3 illustrates a flowchart of a method to provide feedback for real estate, with the system of FIG. 1, in accordance with an embodiment of the disclosure;

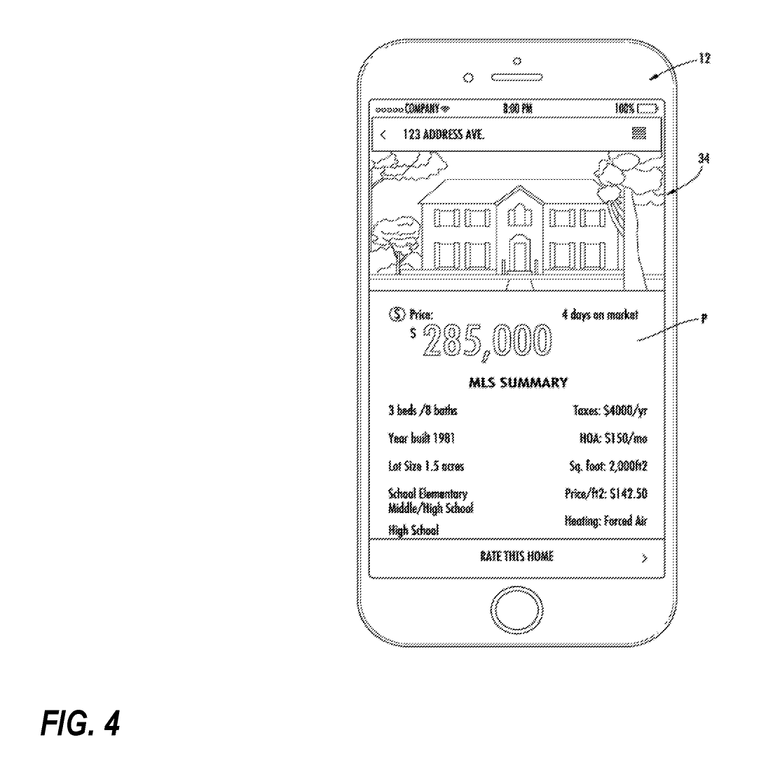

FIG. 4 illustrates a screenshot of the real estate application property listing view, in accordance with an embodiment of the disclosure;

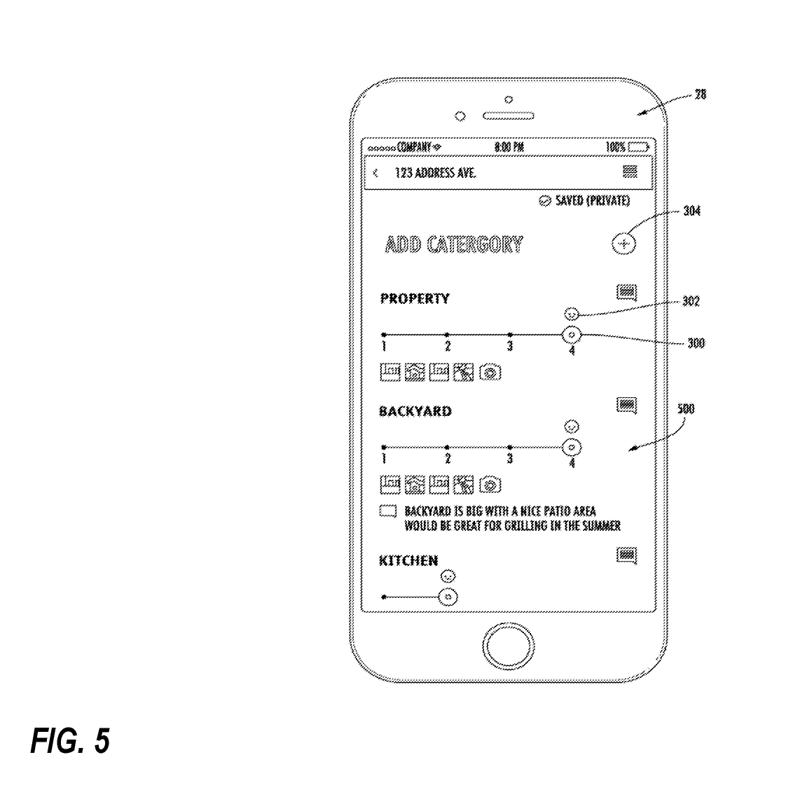

FIG. 5 illustrates a screenshot of the real estate application feedback view, in accordance with an embodiment of the disclosure;

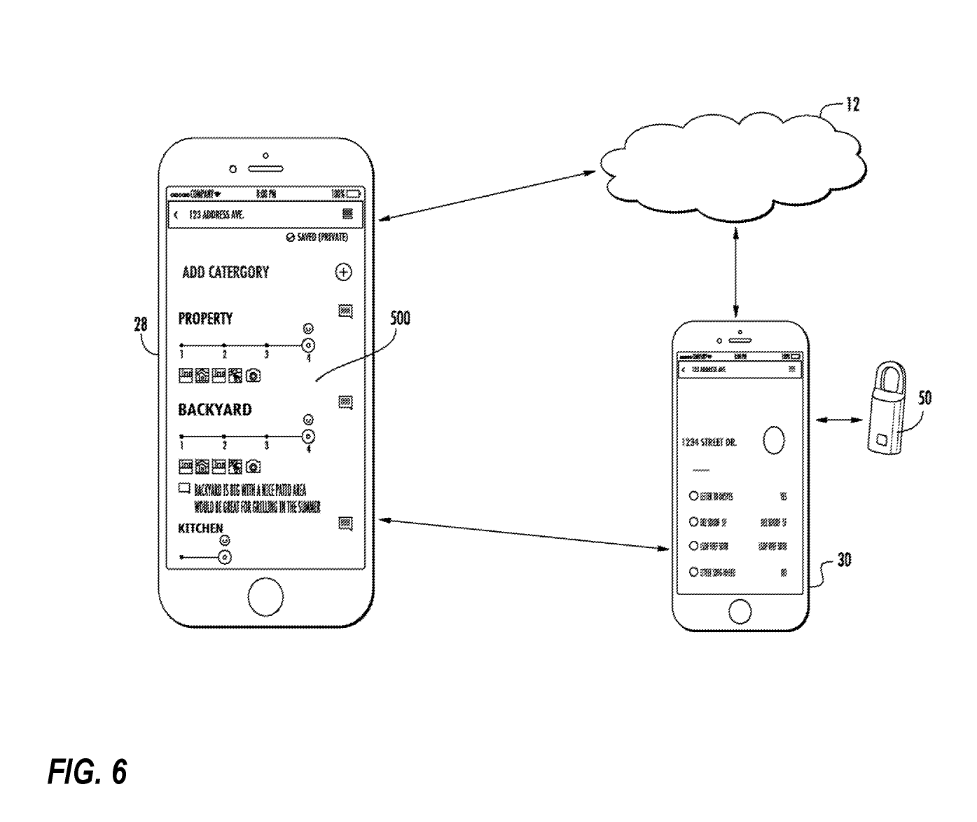

FIG. 6 illustrates a schematic diagram of a system to provide feedback for real estate which is a portion of the system of FIG. 1, in accordance with an embodiment of the disclosure;

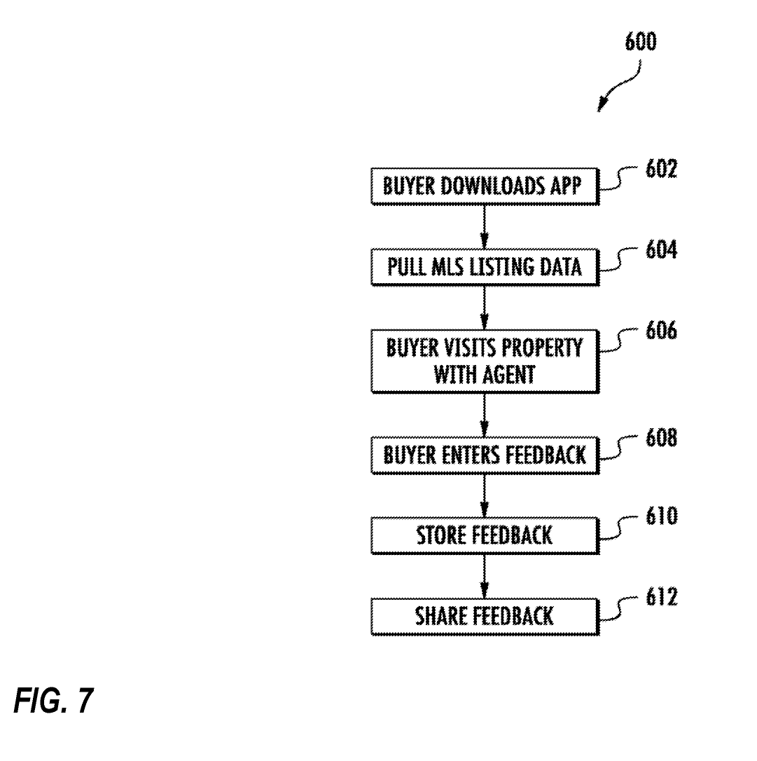

FIG. 7 illustrates a flowchart to provide feedback from a buyer's user device, in accordance with an embodiment of the disclosure;

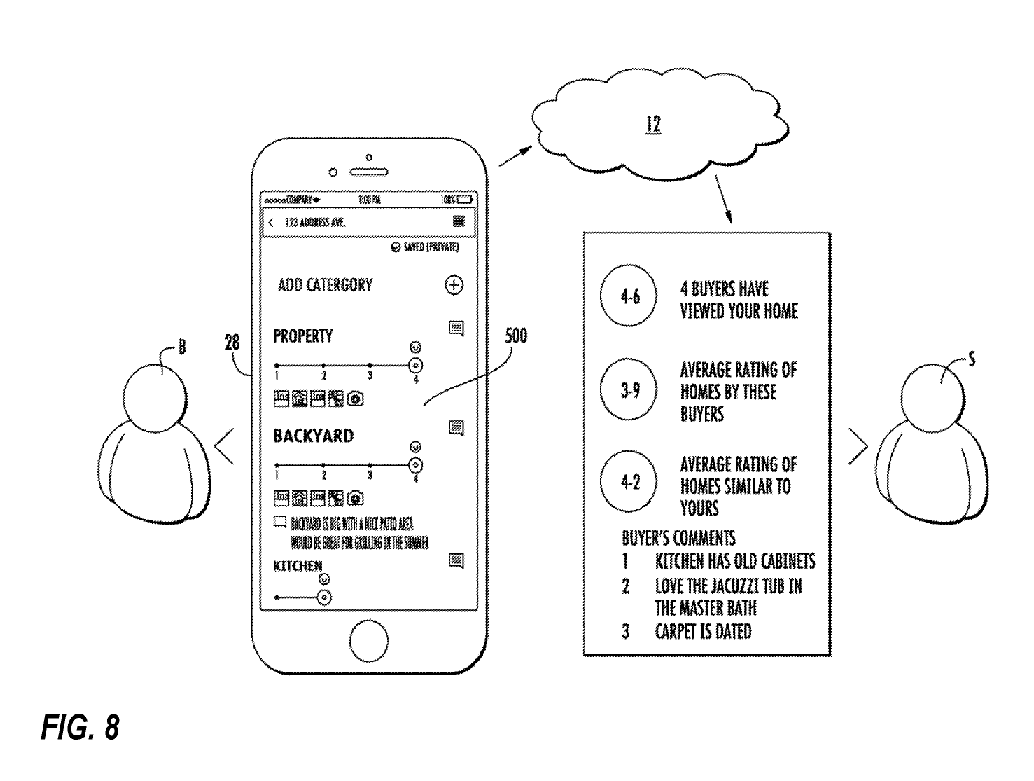

FIG. 8 illustrates a schematic block diagram of feedback provided from a buyer's user device to a seller, in accordance with an embodiment of the disclosure; and

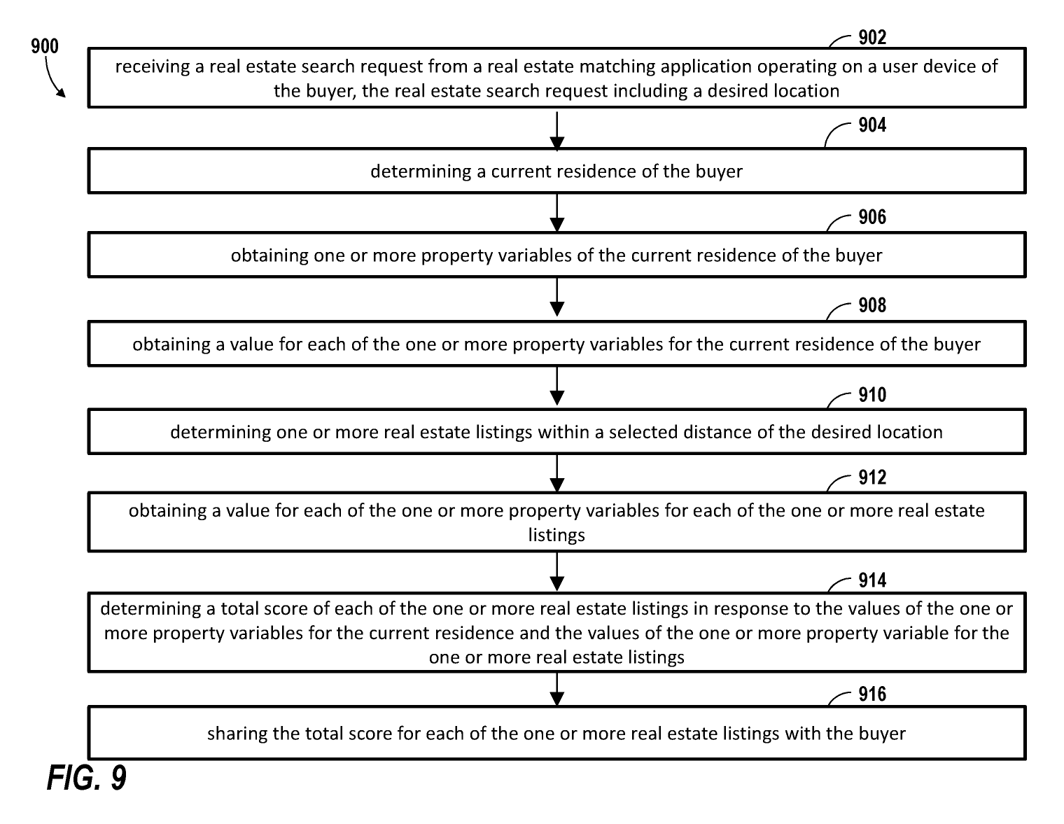

FIG. 9 is a flow diagram illustrating a method of finding a real estate listing similar to a current residence of a buyer, according to an embodiment of the present disclosure.

### DETAILED DESCRIPTION

A detailed description of one or more embodiments of the disclosed apparatus and method are presented herein by way of exemplification and not limitation with reference to the Figures.

FIG. 1 schematically illustrates a system 10 to facilitate communication for real estate transactions. A showing agent “R” has a fiduciary duty to a home buyer “B” while a listing agent “L” has a fiduciary duty to a home seller “S.” The showing agent “R” typically shows the property to the home buyer “B.” The listing agent “L” typically communicates with the buyer “B” only indirectly, such as by communication with the showing agent “R” who then communicates information to and from the buyer “B.” Although only particular agents are referred to in the illustrated embodiments, the functions of such personnel may be otherwise assigned or rearranged. For example, the listing agent “L” may utilize a seller's assistant.

Showing information is accessible through the system 10 so that the listing agent “L” can generate reports for their seller “S”, send updates about a particular listing to showing agents “R” who recently showed that listing. Data generated by an electronic key box 50 may depict information on showings, such as number of showings, time spent at the subject property, return showings, etc. Listing agents “L” may also use the system 10 to receive automatic notification (e.g., email notices) when a showing occurs at their listings. The buyer “B” may also benefit as the system 10 provides a central repository for buyer information (e.g., details of each home the buyer has viewed). A buyer “B” may review real estate listings through a real estate application 38 on a user device 28. A buyer “B” may also rate each real estate listing through the real estate application 38. The rating may rate various aspects of the real estate listing in order to generate an average attractiveness score, which may be an average of each rating from multiple different buyers.

The system 10 generally includes a subsystem 12 that may be controlled by a single owner. The subsystem 12 generally includes a listing recommendation server 14, a buyer server 16, a buyer database system 18, a log database system 20, and an electronic key server 22. A multiple of user devices 28, 30, 32, communicate with the subsystem 12. The first user device 28 is herein associated with the potential buyer “B,” the second user device 30 is associated with the showing agent “R” and the third user device 32 is associated with the listing agent “L.”

“Server” conveys its customary meaning and further includes a corporate datacenter that provides service and/or data connection, e.g., to the user device and/or an electronic locking device.

The “user device” may be a non-portable computing device such as a desktop computer. The “user device” may also refer to a portable electronic computing device that is at least configured to send messages to, and/or receive messages from the listing recommendation server 14 over a long-range wireless communication network, such as a SMS, wireless, or cellular network. Examples of user devices include, but are not limited to: a cell phone; a personal digital assistant (“PDA”); a portable computer configured to store and playback digital pictures, songs, and/or videos; and the like. In addition, the user device is typically also configured for short-range wireless communications. The “user device” may also be two separate devices that are synced together such as, for example, a cellular phone and a desktop computer synced over an interne connection.

The listing recommendation server 14 communicates with the buyer database system 18, the log database system 20, and a data center 24. The buyer database system 18 includes a database 19 that stores rating and notes taken by the buyer “B,” and the log database system 20 includes a database 21 that collects activity data. The buyer data base system 18 may also store property variables, selected multipliers for each property variable, a real estate search request, a desired location of the real estate search, and a current residence of the buyer “B”, all of which are discussed in further detail below. The data center 24 may host one or more servers that may include, but not be limited to, a database for managing key holders 25A, a security database 25B that hosts security protocols, and a listing database 25C that stores extracted real estate listings from external servers 26A, 26B, 26N. The real estate listing is the description of a property via a system, such as for example an application, a website, or similar apparatus known to one of skill in the art.

The data center 24 communicates with the external data servers 26A-26N such as a Real Estate Transaction Standard (RETS) framework that stores MLS data. The MLS data includes information such as number of bedrooms, number of bathrooms, price of listing, etc. RETS is a framework that can be adopted by computer systems to receive data from the Multiple Listing Service (MLS) servers, as well as those of other real estate systems provided they also have software installed designed to communicate using the RETS framework. The National Association of Realtors refers to RETS as a “common language.” The data center 24 may also host real estate servers including a database for managing key box inventories, a security database that houses security protocols, a listing database of property listings, and/or other databases.

The listing recommendation server 14 hosts, for example, at least an analytics software application 32 that compiles and runs analytics against MLS listing data from the data center 24. The buyer server 16 hosts a buyer application program interface (API) 34, and the electronic key server 22 hosts an electronic key API 36. An application program interface (API) is a set of routines, protocols, and tools for building software applications. An API specifies how software components should interact. APIs are used when programming graphical user interface (GUI) components. A server-side web API is a programmatic interface consisting of one or more publicly exposed endpoints to a defined request-response message system

The listing recommendation server 14 communicates with a real estate application 38 on the user device 28 through the buyer API 34 and buyer database system 18. An agent application 40 on the user device 30 communicates with the listing recommendation server 14 and the electronic key server 22. The buyer API 34 and the electronic key API 36 also communicate with the data center 24 through a firewall “F” or other security protocol.

The real estate application 38 may be a mobile application that may be used by the home buyer “B” to rate the properties they have seen via, for example, recordation of feedback and cataloging of the properties of interest. The real estate application 38 may be a mobile application that may be used by the home buyer “B” to enter property variables, selected multipliers for each property variable, the real estate search request, the desired location of the real estate search, and the current residence of the buyer “B”. The real estate application 38 communicates with the buyer database system 18 through the buyer API 34 which then stores the ratings, notes, property variables, selected multipliers for each property variable, the real estate search request, the desired location of the real estate search, and the current residence of the buyer “B” in the buyer database system 18.

The agent application 40 may be a mobile application that may be used by the showing agent “R” to access the electronic key boxes 50. The electronic key API 36 communicates with the agent application 40 to sync activity from the electronic key boxes 50 to the electronic key API 36 (e.g., key boxes the key has opened), and showing notifications (e.g., messages about accessed key boxes and associated showing agent “R”).

With reference to FIG. 2, each user device 28, 30, 32, generally includes a user device antenna 60, a user device transceiver 62, a user device processor 64, a user device memory 66, a location determination module 68, an input device 70, a display 72, an alert device 76, and a user device power supply 74. The user device processor 64 may be any type of microprocessor having desired performance characteristics. The user device memory 66 may include any type of computer readable medium that stores the data and executable instructions described herein below. The executable instructions may be stored or organized in any manner and at any level of abstraction, such as in connection with one or more applications, processes, routines, procedures, methods, etc. The user device transceiver 62 is a transceiver of a type corresponding to the transceiver 62 and the user device antenna 60 is a corresponding antenna. The location determination module 68 may be a GPS module in a non-limiting example. The alert device 76 is configured to activate an alarm 77. In three non-limiting examples, the alert device 76 may be a vibration motor, audio speaker, and/or display screen. The alarm 77 may be audible, visual, haptic, and/or vibratory.

With reference to FIG. 3, a method 200 for operation of the system 10 is disclosed in terms of functional block diagrams. The functions are programmed software routines capable of execution in various microprocessor based electronics control embodiments and represented herein as block diagrams.

Initially, the owner of the subsystem 12 may have agreements with MLS to selectively extract (202) MLS data from the external data servers 26A-26N (FIG. 1) into the listing recommendation server 14. Next, the agent application 40 syncs (204) with the listing recommendation server 14 and pulls MLS data for desired listings. This may be performed through an automated sync through the agent application 40. The showing agent “R” may also do a manual sync to obtain updated MLS data.

Through the agent application 40, the showing agent “R” can authorize (206) the home buyer “B” to access the desired listings of interest to the buyer “B”. Through the agent application 40, the showing agent “R” authorizes the buyer “B” through input of buyer identification information (e.g., name and email address.) The buyer identification information is then synced with the listing recommendation server 14. The listing recommendation server 14 then communicates with the buyer “B” (e.g., via email) that can include a link to an app store and a code to unlock (208) the real estate application 38. The buyer “B” is then authorized to download the real estate application 38 and desired listings, or to maintain the value of the showing agent “R” in the real estate transaction.

Through the agent application 40, the showing agent “R” can continue to push (210) listings to the real estate application 38. Access may be provided for one or more properties by a showing code, or other link to unlock one or more features in the real estate application 38. The showing agent “R” is able to selectively push properties (one example property illustrated by screenshot “P”; FIG. 4) to be viewable within the real estate application 38. The showing agent “R” also uses the agent application 40 to operate the electronic key box 50 to access the property for showing to the buyer “B.”

Next, during the showing, feedback is entered into the real estate feedback application 500 by the buyer “B” for the property (step 216; FIG. 5 and FIG. 6) as further discussed below. The feedback may include any data that can be later used for reviewing and comparing properties. The real estate feedback application 500 may be a module of the real estate application 38, and/or other application.

In addition to the features discussed above, the buyer “B” can utilize the real estate feedback application 500 to record feedback for each property visited. In one embodiment, the buyer “B” can take pictures, videos, and/or notes during the property showing. In another embodiment, the feedback may be provided as a scale rating (FIG. 5). For example, the scale rating may be numeric 300 (e.g., 1-10), emoji based 302 (e.g., happy face, sad face), color coded (e.g., red, yellow, green), or other such ranking. Further, the rating may be specific to particular rooms of the property, (e.g., overall property, backyard, kitchen, etc.) and/or features, (e.g., appliances, fixtures, etc.). In another embodiment, the buyer is prompted for feedback. In another embodiment, the buyer is prompted for feedback based on the location of the buyer within the property (e.g., via global positioning of the buyer within the property by way of the GPS module 68 (FIG. 2)) such that when the buyer enters, for example, the kitchen, the real estate feedback application 500 prompts the buyer for feedback on the kitchen, etc. In still another embodiment, the buyer can add a category 304 to provide feedback thereon (e.g., garage).

The feedback is then saved in memory 66 (FIG. 2) via the real estate feedback application 500 so that the buyer can review at a later time (step 218). The feedback can also be used to compare properties reviewed by the buyer.

As the buyer generates feedback about the listing, the real estate feedback application 500 uploads this data to the buyer API 20 (step 220; FIG. 1). Once the showing is complete, the buyer can decide to share the ratings with their showing agent “R” via the real estate feedback application 500 which authorizes the listing recommendation server to release the ratings 14 from the buyer database 19.

The agent application 40 then syncs with the listing recommendation server 14 and downloads the feedback (step 222). The showing agent “R” is then able to review ratings and comments on the agent application 40.

Through the agent application 40, the showing agent “R” can communicate the feedback to the listing agent “L” (step 224). In one embodiment, the feedback may be forwarded through an email app on the user device 30, and need not be through the subsystem 12. For example, an email app resident on the user device 30 is called by the agent application 40, and the feedback is automatically copied into the email body. The showing agent “R” may then edit the email body prior to sending the feedback to the listing agent “S.”

With reference to FIG. 7, a method 600 for providing feedback via the real estate feedback application 500 from the perspective of the buyer “B” is disclosed in terms of functional block diagrams. The functions are programmed software routines and executable instructions capable of execution in various microprocessor based electronics control embodiments and represented herein as block diagrams.

Initially, the buyer “B” downloads the real estate feedback application 500 from a source such as an app store (step 602). The real estate feedback application 500 communicates (step 604) with the listing recommendation server 14 via the buyer API 34 to pull the agent selected MLS listings. The showing agent “R” then typically escorts the buyer “B” for a showing of particular properties selected by the buyer (step 606). Next, the feedback is entered (step 608; FIG. 5) into the real estate feedback application 500 by the buyer “B” for the particular property. The feedback is then saved via the real estate feedback application 500 so that the buyer “B” can review at a later time (step 610). The real estate feedback application 500 can be used by the buyer “B” to review feedback and compare notes on the properties.

Once the showing is complete, the buyer can choose to share the ratings with their showing agent “R” (step 612). If they choose to do so, the real estate feedback application 500 will send a message to the listing recommendation server 14 though the buyer API 20 to release the ratings to the showing agent “R.” The feedback may be provided to the listing agent “L” through the subsystem 12. In this embodiment, the real estate feedback application 500 uploads the feedback data from the buyer database 18 to the electronic key server 22 via the buyer API 34 which then generates a report for the listing agent “L” (FIG. 8). The report may include the feedback in a format that may include, but not be limited to, this particular buyer's feedback (i.e., does the buyer like the property?), this particular buyer's feedback as compared to other properties (i.e., how serious is the buyer about the property?), other buyer's feedback comparison for the particular property (i.e., is this a likely buyer?) and/or other buyer's feedback for other properties (i.e., how does the particular property compare with other properties?)

The system and method provides a seller with access to relevant buyer feedback and buyers with a tool for managing properties they visit.

The feedback may be used to generate an average attractiveness rating from multiple buyers “B” for the property. The average attractiveness rating may be an average of the feedback enter by each buyer “B” who visits the property. In an alternative embodiment, the average attractiveness rating may be also determined by crowd sourcing, where users may rank properties remotely through an online application. In a crowd sourcing example, it may not be necessary for users to physically visit properties before ranking. Ranking may be done via an online application in concert with viewing photos or videos of the property. It may be possible to limit crowd sourcing users to only include those that may be possible purchasers of the property by any of credit score, proof of mortgage pre-approval, bank statement or any other means illustrative of the financial ability to purchase the property.

Referring now to FIG. 9, with continued reference to FIGS. 1-8. FIG. 9 shows a flow chart of method 900 of finding a real estate listing similar to a current residence of a buyer “B”, in accordance with an embodiment of the disclosure. At block 902, a real estate search request from a real estate matching application 38 operating on a user device 28 of the buyer “B” is received. The real estate search request includes a desired location. The desired location is a geographical location where the buyer “B” would like to buy real estate. At block 904, a current residence of the buyer “B” is determined. The current residence of the buyer “B” may be either entered by the buyer “B” through the real estate matching application 38 and/or detected by a location determination module 68 through GPS in one non-limiting example.

At block 906, one or more property variables of the current residence of the buyer “B” are obtained. The one or more property variables may be either entered by the buyer “B” through the real estate matching application 38 and/or may be standard. Property variable may include at least one of property type, year built, lot size, number of bedrooms, number of bathrooms, basement, garage, square feet, location schools, price, taxes, price history, tax history, and average attractiveness score. Property variables may further include at least one of cooling type, heating type, appliances included, attic, number of rooms, fireplace, exterior material, driveway type, porch, sewer, and water supply type. It is understood that the property variable may include other property variables not list herein.

At block 908, a value for each of the one or more property variables for the current residence of the buyer “B” is obtained. The values may be obtained by the listing recommendation server 14 contacting the data center 24 and/or the buyer database 18. Values may include numerical values. An example of property variables and associate values for each property variable may be seen in the Table 1 below. It is understood that while eight property variables are being used to illustrate method 900 are for exemplary purposes and any number of property variables and/or different variables may be used. It is also understood that the values for each variable are for exemplary purposes and the values may change. The property variables used may be selected by the buyer “B” through the real estate matching application 38 on the user device 28.

TABLE 1
Example of Variable and Associated Values for Current residence of buyer
“B”.

| Property Variable | Value |
|---|---|
| Price | $210,000 |
| School District | 10 |
| Walk Score | 66 |
| Beds | 3 |
| Bath | 2 |
| Square Feet | 1500 |
| Year Built | 1983 |
| Average Attractiveness | 7.6 |

At block 910, one or more real estate listings within a selected distance of the desired location are determined. The one or more real estate listings may include a first real estate listing, a second real estate listing, a third real estate listing, . . . , an “n^{th}” real estate listing. The desired location may be selected by the buyer “B” through the real estate matching application 38 on the user device 28. For example, a buyer “B” may desire to be within 15 mile radius of work and thus the desired location may be the location of the buyer's “B” work and the selected distance may be 15 miles. The listing recommendation server 14 communicates with the data center 24 in order to determine one or more real estate listings within the selected distance of the desired location.

At block 912, a value for each of the one or more property variables for each of the one or more real estate listings is obtained. The listing recommendation server 14 communicates with the data center 24 in order to determine one or more property variables for each of the one or more real estate listings.

In the example of Table 2, shown below, three real estate listings are being shown for comparison, along with the value for each property variable for each real estate listing. It is understood that while the example being used to illustrate method 900 utilizes three real estate listings, any number of real estate listings may be used. It is also understood that the values for each property variable are for exemplary purposes and the values may change. The property variables shown in Table 2 include Price, School district, walk score, beds, bath, square feet, year built, and average attractiveness. The property variables may be pulled from existing databases, such as, for example, the school district rating may be pulled from greatschools.com and/or niche.com; or a walk score may be pulled from walkscore.com.

TABLE 2
Example of Property Variables and Associated Values for real estate
listings within the selected distance of the desired location.

| | Values | | |
|---|---|---|---|
| | Real | Real | Real |
| | Estate | Estate | Estate |
| Property Variable | Listing 1 | Listing 2 | Listing 3 |
| Price | $250,000 | $190,000 | $190,000 |
| School District | 10 | 8 | 7 |
| Walk Score | 80 | 55 | 75 |
| Beds | 3 | 3 | 4 |
| Bath | 2.5 | 2 | 2 |
| Square Feet | 1700 | 1400 | 1800 |
| Year Built | 1989 | 1995 | 1975 |
| Average Attractiveness | 8.5 | 8.2 | 7.2 |

At block 914, a total score of each of the one or more real estate listings is determined in response to the values of the one or more property variables for the current residence and the values of the one or more property variable for the one or more real estate listings. The total scores may be determined using equations (i)-(iii) below. First in equations (i) the percentage of change (% ΔRELₓVariableᵢ) between each property variable of the current residence (CRVariableᵢ) and the variable of each real estate listing(RELₓVariableᵢ).

$$\frac{100 * ( {CR Variable}_{i} - {REL}_{x} {Variable}_{i}}{{REL}_{x} {Variable}_{i}} = \% Δ {REL}_{x} {Variable}_{i} \qquad ( i )$$

After the percentage change (% ΔRELₓVariableᵢ) of each variable is determined then the percentage change may be multiplied by a selected multiplier as seen in equation (ii) to determine a variable score for each property variable for each real estate listing (RELₓVariableᵢScore). The selected multiplier may be determined by the buyer “B” through real estate matching application 38 on the user device 28. The selected multiplier represents the importance of each property variable to the buyer “B”. For example, a property variable having a multiplier with a lower number may be of more importance to the buyer “B” than a property variable having a multiplier with a higher number.

% ΔRELₓVariableᵢ*Multiplier=RELₓVariableᵢScore (ii)

Once the variable score (RELₓVariableᵢScore) of the one or more property variables for each real estate listing is determined then the variable scores for each real estate listing are summed to determine a total score for each real estate listing, as shown by equation (iii).

Σᵢ₌₁ⁿRELₓVariableᵢScore=Total Score (iii)

Once the Total Score is determined for each real estate listing then the real estate listings may be sorted in ascending order by the total score to be compared. The lowest total score is the real estate listing that most closely matches the current residence of the buyer “B”. Tables 3-5 list the calculated values from each real estate listing to determine the total score.

TABLE 3
Total Score Determination for Real Estate Listing 1.

| Property | Real Estate | Percentage | | Variable |
|---|---|---|---|---|
| Variable | Listing 1 | Change | Multiplier | Score |
| Price | $250,000 | 19.04762 | 5 | 95.2381 |
| School District | 10 | 0 | 5 | 0 |
| Walk Score | 80 | 21.21212 | 5 | 106.0606 |
| Beds | 3 | 0 | 5 | 0 |
| Bath | 2.5 | 25 | 1 | 25 |
| Square Feet | 1700 | 13.33333 | 1 | 13.33333 |
| Year Built | 1989 | 0.302572 | 1 | 0.302572 |
| Average | 8.5 | 11.84211 | 5 | 59.21053 |
| Attractiveness | | | | |

| | |
|---|---|
| Total Score | 299.1451 |

TABLE 4
Total Score Determination for Real Estate Listing 2.

| Property | Real Estate | Percentage | | Variable |
|---|---|---|---|---|
| Variable | Listing 2 | Change | Multiplier | Score |
| Price | $250,000 | 9.52381 | 5 | 47.61905 |
| School District | 10 | 20 | 5 | 100 |
| Walk Score | 80 | 16.66667 | 5 | 83.33333 |
| Beds | 3 | 0 | 5 | 0 |
| Bath | 2.5 | 0 | 1 | 0 |
| Square Feet | 1700 | 6.666667 | 1 | 6.666667 |
| Year Built | 1989 | 0.605144 | 1 | 0.605144 |
| Average | 8.5 | 7.894737 | 5 | 39.47368 |
| Attractiveness | | | | |

| | |
|---|---|
| Total Score | 277.6979 |

TABLE 5
Total Score Determination for Real Estate Listing 3.

| Property | Real Estate | Percentage | | Variable |
|---|---|---|---|---|
| Variable | Listing 3 | Change | Multiplier | Score |
| Price | $250,000 | 9.52381 | 5 | 47.61905 |
| School District | 10 | 20 | 5 | 100 |
| Walk Score | 80 | 16.66667 | 5 | 83.33333 |
| Beds | 3 | 0 | 5 | 0 |
| Bath | 2.5 | 0 | 1 | 0 |
| Square Feet | 1700 | 6.666667 | 1 | 6.666667 |
| Year Built | 1989 | 0.605144 | 1 | 0.605144 |
| Average | 8.5 | 7.894737 | 5 | 39.47368 |
| Attractiveness | | | | |

| | |
|---|---|
| Total Score | 479.1868 |

At block 916, the total scores for each of the one or more real estate listings are shared with the buyer “B”. As can be seen from Tables 3-5, Real Estate Listing 2 had the lowest total score and thus may appear at the top of a list of the one or more real estate listings that is shared the buyer “B”. The total scores for each of the one or more real estate listings may be shared with the buyer “B” through the real estate application 38 on the user device 28. An alarm 77 may be activated by the alert device 76, when the total scores for each of the one or more real estate listings are received through the real estate application 38 on the user device 28. The total scores may be displayed on a screen of the user device 28, when the total scores for each of the one or more real estate listings are received through the real estate application 38 on the user device 28.

While the above description has described the flow process of FIG. 9 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of finding a real estate listing similar to a current residence of a buyer, the method comprising:
receiving a real estate search request from a real estate matching application operating on a user device of the buyer, the real estate search request including a desired location;
determining a current residence of the buyer;
obtaining one or more property variables of the current residence of the buyer;
obtaining a value for each of the one or more property variables for the current residence of the buyer;
determining a first real estate listing within a selected distance of the desired location;
obtaining a value for each of the one or more property variables for the first real estate listing;
determining a total score of the first real estate listing in response to the value for each of the one or more property variables for the current residence of the buyer and the value for each of the one or more property variables for the first real estate listing; and
sharing the total score of the first real estate listing with the buyer.

2. The method of claim 1, wherein the determining a total score of the first real estate listing further comprises:
determining a percentage change between the value for each of the one or more property variables for the current residence and the value for each of the one or more property variables for first real estate listing; and
summing the percentage change for each of the one or more property variables to determine a total score.

3. The method of claim 1, wherein the determining a total score of the first real estate listing further comprises:
determining a percentage change between the value for each of the one or more property variables for the current residence and the value for each of the one or more property variables for first real estate listing;
multiplying each of the percentage change for each of the one or more property variables by a selected variable multiplier; and
summing the percentage change for each of the one or more property variables to determine a total score.

4. The method of claim 1, further comprising:
determining a second real estate listing within a selected distance of the desired location;
obtaining a value for each of the one or more property variables for the second real estate listing;
determining a total score of the second real estate listing in response to the value for each of the one or more property variables for the current residence of the buyer and the value for each of the one or more property variables for the second real estate listing; and
sharing with the buyer the total score of the second real estate listing.

5. The method of claim 4, wherein the determining a total score of the second real estate listing further comprises:
determining a percentage change between the value for each of the one or more property variables for the current residence and the value for each of the one or more property variables for second real estate listing; and
summing the percentage change for each of the one or more property variables to determine a total score.

6. The method of claim 4, wherein the determining a total score of the second real estate listing further comprises:
determining a percentage change between the value for each of the one or more property variables for the current residence and the value for each of the one or more property variables for second real estate listing;
multiplying each of the percentage change for each of the one or more property variables by a selected variable multiplier; and
summing the percentage change for each of the one or more property variables to determine a total score.

7. The method of claim 5, further comprising:
sorting the first real estate property and the second real estate property in order of ascending total score.

8. The method of claim 6, further comprising:
sorting the first real estate property and the second real estate property in order of ascending total score

9. The method of claim 1, further comprising:
activating an alarm on a user device of the buyer through a real estate application when the total score of the first real estate property is received.

10. The method of claim 1, further comprising:
displaying the total score of the first real estate property on a user device of the buyer through a real estate application when the total score of the first real estate property is received.

11. The method of claim 4, further comprising:
activating an alarm on a user device of the buyer through a real estate application when the total score of the second real estate property is greater than the total score of the first real estate property.

12. A listing recommendation server comprising:
a processor;
a memory comprising computer-executable instructions that, when executed by the processor, cause the processor to perform operations, the operations comprising:
determining a current residence of the buyer;
obtaining one or more property variables of the current residence of the buyer;
obtaining a value for each of the one or more property variables for the current residence of the buyer;
determining a first real estate listing within a selected distance of the desired location;
obtaining a value for each of the one or more property variables for the first real estate listing;
determining a total score of the first real estate listing in response to the value for each of the one or more property variables for the current residence of the buyer and the value for each of the one or more property variables for the first real estate listing; and
sharing the total score of the first real estate listing with the buyer.

13. The listing recommendation server of claim 12, wherein the determining a total score of the first real estate listing further comprises:
determining a percentage change between the value for each of the one or more property variables for the current residence and the value for each of the one or more property variables for first real estate listing; and
summing the percentage change for each of the one or more property variables to determine a total score.

14. The listing recommendation server of claim 12, wherein the determining a total score of the first real estate listing further comprises:
determining a percentage change between the value for each of the one or more property variables for the current residence and the value for each of the one or more property variables for first real estate listing;
multiplying each of the percentage change for each of the one or more property variables by a selected variable multiplier; and
summing the percentage change for each of the one or more property variables to determine a total score.

15. The listing recommendation server of claim 12, wherein the operations further comprise:
determining a second real estate listing within a selected distance of the desired location;
obtaining a value for each of the one or more property variables for the second real estate listing;
determining a total score of the second real estate listing in response to the value for each of the one or more property variables for the current residence of the buyer and the value for each of the one or more property variables for the second real estate listing; and
sharing with the buyer the total score of the second real estate listing.

16. The listing recommendation server of claim 15, wherein the determining a total score of the second real estate listing further comprises:
determining a percentage change between the value for each of the one or more property variables for the current residence and the value for each of the one or more property variables for second real estate listing; and
summing the percentage change for each of the one or more property variables to determine a total score.

17. The listing recommendation server of claim 15, wherein the determining a total score of the second real estate listing further comprises:
determining a percentage change between the value for each of the one or more property variables for the current residence and the value for each of the one or more property variables for second real estate listing;
multiplying each of the percentage change for each of the one or more property variables by a selected variable multiplier; and
summing the percentage change for each of the one or more property variables to determine a total score.

18. The listing recommendation server of claim 16, wherein the operations further comprise:
sorting the first real estate property and the second real estate property in order of ascending total score.

19. The listing recommendation server of claim 17, wherein the operations further comprise:
sorting the first real estate property and the second real estate property in order of ascending total score.

20. A computer program product tangibly embodied on a computer readable medium, the computer program product including instructions that, when executed by a processor, cause the processor to perform operations comprising:
determining a current residence of the buyer;
obtaining one or more property variables of the current residence of the buyer;
obtaining a value for each of the one or more property variables for the current residence of the buyer;
determining a first real estate listing within a selected distance of the desired location;
obtaining a value for each of the one or more property variables for the first real estate listing;
determining a total score of the first real estate listing in response to the value for each of the one or more property variables for the current residence of the buyer and the value for each of the one or more property variables for the first real estate listing; and
sharing the total score of the first real estate listing with the buyer.
